(19) United States
(12) Patent Application Publication
(10) Pub. No.: US 2025/0106832 A1
(43) Pub. Date: Mar. 27, 2025

(54) TECHNIQUES FOR CONFIGURING MULTIPLE SUPPLEMENTAL UPLINK FREQUENCY BANDS PER SERVING CELL

(71) Applicant: QUALCOMM INCORPORATED, San Diego, CA (US)

(72) Inventors: Yiqing Cao, Beijing (CN); Peter Gaal, San Diego, CA (US); Kazuki Takeda, Minato-ku (JP); Masato Kitazoe, Hachiouji-shi (JP)

(21) Appl. No.: 18/729,487

(22) PCT Filed: Mar. 25, 2022
(86) PCT No.: PCT/CN2022/083005

§ 371 Date: Jul. 16, 2024

(51) Int. Cl. H04W 72/0453

(52) U.S. Cl. CPC H04W 72/0453

(57) ABSTRACT

Methods, systems, and devices for wireless communications are described. A user equipment (UE) may transmit a message to a network entity, such as a base station, indicating a capability of the UE to support multiple supplemental uplink frequency bands bundled to a serving cell. The UE may transmit the capability in a capability report with other capability information, or independent of a capability report. The UE may receive an information element (IE) in control signaling. The IE may indicate a set of supplemental uplink frequency bands for the serving cell. Each supplemental uplink frequency band may span one or more supplemental uplink carriers. The UE may receive additional control signaling scheduling one or more uplink transmissions on at least one supplemental uplink frequency band for the serving cell.

### CROSS REFERENCE

The present application is a 371 national stage filing of International PCT Application No. PCT/CN2022/083005 by Cao et al. entitled “TECHNIQUES FOR CONFIGURING MULTIPLE SUPPLEMENTAL UPLINK FREQUENCY BANDS PER SERVING CELL,” filed Mar. 25, 2022, which is assigned to the assignee hereof, and which is expressly incorporated by reference in its entirety herein.

### FIELD OF DISCLOSURE

The following relates to wireless communications, including techniques for configuring multiple supplemental uplink frequency bands per serving cell.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for configuring multiple supplemental uplink frequency bands per serving cell, which may also be referred to as a network entity. For example, a user equipment (UE) may transmit a message indicating a capability of the UE to support multiple supplemental uplink frequency bands for a single serving cell. The UE may receive an information element (IE) in control signaling (e.g., radio resource control (RRC) signaling) from a different network entity, such as a base station. The IE may configure the UE with a set of supplemental uplink frequency bands, each frequency band spanning one or more carriers. For example, the IE may include a table or a list of available supplemental uplink frequency bands. In some examples, the UE may receive additional control signaling (e.g., a downlink control information (DCI) message, a medium access control-control element (MAC-CE), or the like) scheduling one or more uplink transmissions on at least one of the supplemental uplink frequency bands.

A method for wireless communication at a UE is described. The method may include transmitting a message indicating a capability of the UE to support a set of multiple supplemental uplink frequency bands bundled to a serving cell and receiving first control signaling including an IE indicating the set of multiple supplemental uplink frequency bands, where the set of multiple supplemental uplink frequency bands are associated with a set of multiple supplemental uplink carriers corresponding to the serving cell.

An apparatus for wireless communication at a UE is described. The apparatus may include a processor, memory coupled with the processor, and instructions stored in the memory. The instructions may be executable by the processor to cause the apparatus to transmit a message indicating a capability of the UE to support a set of multiple supplemental uplink frequency bands bundled to a serving cell and receive first control signaling including an IE indicating the set of multiple supplemental uplink frequency bands, where the set of multiple supplemental uplink frequency bands are associated with a set of multiple supplemental uplink carriers corresponding to the serving cell.

Another apparatus for wireless communication at a UE is described. The apparatus may include means for transmitting a message indicating a capability of the UE to support a set of multiple supplemental uplink frequency bands bundled to a serving cell and means for receiving first control signaling including an IE indicating the set of multiple supplemental uplink frequency bands, where the set of multiple supplemental uplink frequency bands are associated with a set of multiple supplemental uplink carriers corresponding to the serving cell.

A non-transitory computer-readable medium storing code for wireless communication at a UE is described. The code may include instructions executable by a processor to transmit a message indicating a capability of the UE to support a set of multiple supplemental uplink frequency bands bundled to a serving cell and receive first control signaling including an IE indicating the set of multiple supplemental uplink frequency bands, where the set of multiple supplemental uplink frequency bands are associated with a set of multiple supplemental uplink carriers corresponding to the serving cell.

Some examples of the method, apparatuses, and non-transitory computer-readable medium described herein may further include operations, features, means, or instructions for receiving second control signaling including control information associated with at least one supplemental uplink frequency band of the set of multiple supplemental uplink frequency bands, the control information scheduling one or more uplink transmissions on a carrier frequency of the serving cell, the set of multiple supplemental uplink carriers, or both.

Some examples of the method, apparatuses, and non-transitory computer-readable medium described herein may further include operations, features, means, or instructions for receiving a multi-bit indicator in the control information, the multi-bit indicator corresponding to the at least one supplemental uplink frequency band of the set of multiple supplemental uplink frequency bands and transmitting the one or more uplink transmissions on the at least one supplemental uplink frequency band based on the multi-bit indicator.

In some examples of the method, apparatuses, and non-transitory computer-readable medium described herein, the control information includes a parameter indicating the at least one supplemental uplink frequency band.

In some examples of the method, apparatuses, and non-transitory computer-readable medium described herein, the control information activates the at least one supplemental uplink frequency band for the one or more uplink transmissions.

In some examples of the method, apparatuses, and non-transitory computer-readable medium described herein, the control information includes DCI.

Some examples of the method, apparatuses, and non-transitory computer-readable medium described herein may further include operations, features, means, or instructions for determining a maximum number of supplemental uplink frequency bands, where a number of supplemental uplink frequency bands supported by the UE may be based on the maximum number of supplemental uplink frequency bands.

In some examples of the method, apparatuses, and non-transitory computer-readable medium described herein, the message includes a capability report, the capability of the UE to support the set of multiple supplemental uplink frequency bands being a parameter of the capability report.

In some examples of the method, apparatuses, and non-transitory computer-readable medium described herein, the first control signaling includes RRC signaling.

In some examples of the method, apparatuses, and non-transitory computer-readable medium described herein, the set of multiple supplemental uplink carriers correspond to a single downlink carrier of the serving cell.

A method for wireless communication at a network entity is described. The method may include receiving a message indicating a capability of a UE to support a set of multiple supplemental uplink frequency bands bundled to a serving cell and transmitting first control signaling including an IE indicating the set of multiple supplemental uplink frequency bands, where the set of multiple supplemental uplink frequency bands are associated with a set of multiple supplemental uplink carriers corresponding to the serving cell.

An apparatus for wireless communication at a network entity is described. The apparatus may include a processor, memory coupled with the processor, and instructions stored in the memory. The instructions may be executable by the processor to cause the apparatus to receive a message indicating a capability of a UE to support a set of multiple supplemental uplink frequency bands bundled to a serving cell and transmit first control signaling including an IE indicating the set of multiple supplemental uplink frequency bands, where the set of multiple supplemental uplink frequency bands are associated with a set of multiple supplemental uplink carriers corresponding to the serving cell.

Another apparatus for wireless communication at a network entity is described. The apparatus may include means for receiving a message indicating a capability of a UE to support a set of multiple supplemental uplink frequency bands bundled to a serving cell and means for transmitting first control signaling including an IE indicating the set of multiple supplemental uplink frequency bands, where the set of multiple supplemental uplink frequency bands are associated with a set of multiple supplemental uplink carriers corresponding to the serving cell.

A non-transitory computer-readable medium storing code for wireless communication at a network entity is described. The code may include instructions executable by a processor to receive a message indicating a capability of a UE to support a set of multiple supplemental uplink frequency bands bundled to a serving cell and transmit first control signaling including an IE indicating the set of multiple supplemental uplink frequency bands, where the set of multiple supplemental uplink frequency bands are associated with a set of multiple supplemental uplink carriers corresponding to the serving cell.

Some examples of the method, apparatuses, and non-transitory computer-readable medium described herein may further include operations, features, means, or instructions for transmitting second control signaling including control information associated with at least one supplemental uplink frequency band of the set of multiple supplemental uplink frequency bands, the control information scheduling one or more uplink transmissions on a carrier frequency of the serving cell, the set of multiple supplemental uplink carriers, or both.

Some examples of the method, apparatuses, and non-transitory computer-readable medium described herein may further include operations, features, means, or instructions for transmitting a multi-bit indicator in the control information, the multi-bit indicator corresponding to the at least one supplemental uplink frequency band of the set of multiple supplemental uplink frequency bands and receiving the one or more uplink transmissions on the at least one supplemental uplink frequency band based on the multi-bit indicator.

In some examples of the method, apparatuses, and non-transitory computer-readable medium described herein, the control information includes a parameter indicating the at least one supplemental uplink frequency band.

In some examples of the method, apparatuses, and non-transitory computer-readable medium described herein, the control information activates the at least one supplemental uplink frequency band for the one or more uplink transmissions.

In some examples of the method, apparatuses, and non-transitory computer-readable medium described herein, the control information includes DCI.

In some examples of the method, apparatuses, and non-transitory computer-readable medium described herein, the message includes a capability report, the capability of the UE to support the set of multiple supplemental uplink frequency bands being a parameter of the capability report.

In some examples of the method, apparatuses, and non-transitory computer-readable medium described herein, the first control signaling includes RRC signaling.

In some examples of the method, apparatuses, and non-transitory computer-readable medium described herein, the set of multiple supplemental uplink carriers correspond to a single downlink carrier of the serving cell.

### BRIEF DESCRIPTION OF THE DRAWINGS

FIGS. 1 and 2 illustrate examples of wireless communications systems that support techniques for configuring multiple supplemental uplink frequency bands per serving cell in accordance with one or more aspects of the present disclosure.

FIG. 3 illustrates an example of a process flow that supports techniques for configuring multiple supplemental uplink frequency bands per serving cell in accordance with one or more aspects of the present disclosure.

FIGS. 4 and 5 show block diagrams of devices that support techniques for configuring multiple supplemental uplink frequency bands per serving cell in accordance with one or more aspects of the present disclosure.

FIG. 6 shows a block diagram of a communications manager that supports techniques for configuring multiple supplemental uplink frequency bands per serving cell in accordance with one or more aspects of the present disclosure.

FIG. 7 shows a diagram of a system including a device that supports techniques for configuring multiple supplemental uplink frequency bands per serving cell in accordance with one or more aspects of the present disclosure.

FIGS. 8 and 9 show block diagrams of devices that support techniques for configuring multiple supplemental uplink frequency bands per serving cell in accordance with one or more aspects of the present disclosure.

FIG. 10 shows a block diagram of a communications manager that supports techniques for configuring multiple supplemental uplink frequency bands per serving cell in accordance with one or more aspects of the present disclosure.

FIG. 11 shows a diagram of a system including a device that supports techniques for configuring multiple supplemental uplink frequency bands per serving cell in accordance with one or more aspects of the present disclosure.

FIGS. 12 through 15 show flowcharts illustrating methods that support techniques for configuring multiple supplemental uplink frequency bands per serving cell in accordance with one or more aspects of the present disclosure.

### DETAILED DESCRIPTION

In some wireless communications systems, there may be one or more uplink carriers and one or more downlink carriers that span a set of frequency bands. In some examples, downlink and primary uplink frequency bands may cover relatively high frequencies when compared with a supplementary uplink frequency band. The supplementary uplink frequency band may be located in one or more lower frequency bands to improve uplink coverage and throughput. For example, a serving cell, or network entity, which may support one or more carriers, may be configured with the supplementary uplink frequency band in conjunction with a single downlink frequency band and a single primary uplink frequency band to increase coverage. In some examples, a user equipment (UE) may be configured to use the primary and supplementary uplink carriers spanning one or more primary and supplemental uplink frequency bands, and one downlink carrier spanning one or more downlink frequency bands. However, a UE configured with one supplemental uplink frequency band per serving cell may have less throughput and coverage than if the UE was configured with multiple supplemental uplinks per serving cell.

As described herein, a UE may indicate a capability to support multiple supplementary uplink frequency bands per serving cell to a network entity, such as a base station or serving cell. For example, the network entity may configure multiple supplemental uplink frequency bands, or carriers, for a single uplink carrier frequency of a serving cell. A network entity may transmit an information element (IE), which may be included in radio resource control (RRC) signaling, to configure the UE with the multiple supplementary uplink frequency bands. For example, the IE may include a table, or list, of supplementary uplink frequency bands available to the UE for communications. In some cases, the network entity may transmit downlink control information (DCI) indicating one or more of the supplementary uplink frequency bands for the UE to use for transmissions. For example, the DCI may include a multi-bit value that indicates one or more indices in the list of supplementary uplink frequency bands for the UE to use for a transmission.

Aspects of the disclosure are initially described in the context of wireless communications systems. Aspects of the disclosure are further described in the context of process flows. Aspects of the disclosure are further illustrated by and described with reference to apparatus diagrams, system diagrams, and flowcharts that relate to techniques for configuring multiple supplemental uplink frequency bands per serving cell.

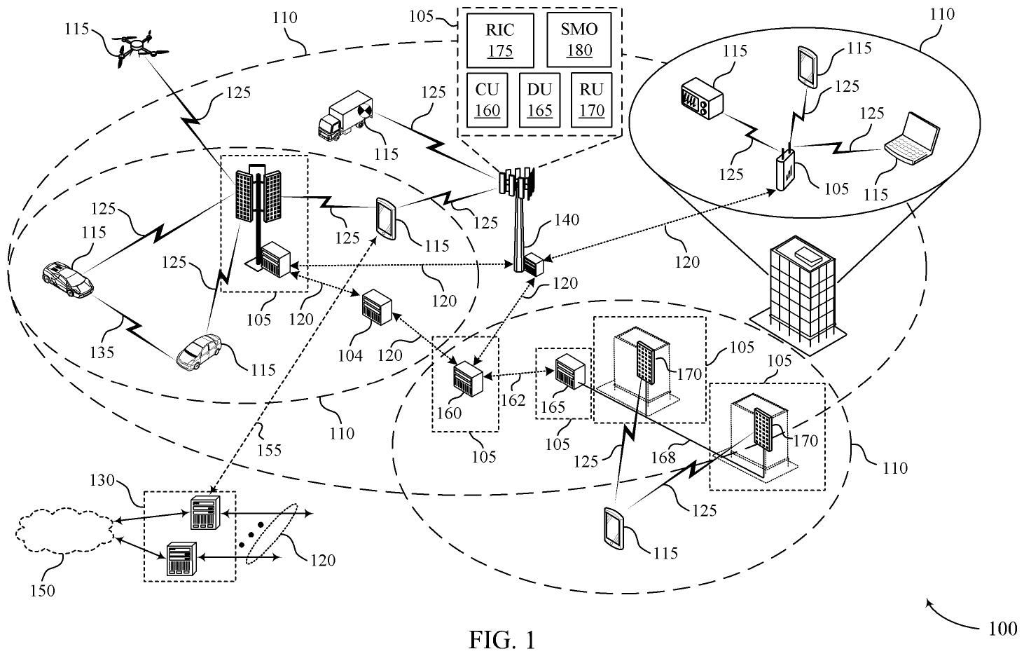

FIG. 1 illustrates an example of a wireless communications system that supports techniques for configuring multiple supplemental uplink frequency bands per serving cell in accordance with one or more aspects of the present disclosure. A wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for configuring multiple supplemental uplink frequency bands per serving cell as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell may cover a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). For example, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with an orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some examples, a network entity 105, or a serving cell, may serve one or more carriers that span a set of frequency bands. The wireless communications system 100 may implement a supplemental uplink carrier, or supplementary uplink carrier, which may be an additional carrier of a serving cell. The network entity 105 may transmit a configuration for a supplemental uplink carrier for a UE 115 to use for an uplink transmission at a serving cell. However, using a single supplemental uplink carrier per serving cell may decrease uplink throughput when compared with using multiple supplemental uplink carriers per serving cell.

As described herein, the network entity 105 may configure multiple supplement uplink carriers per serving cell to increase throughput. In some cases, a UE 115 may determine a capability to support multiple supplemental uplink frequency bands per serving cell, which may span multiple carriers. The UE 115 may indicate to the network entity 105 whether the UE 115 supports multiple supplemental uplink carriers using a UE capability message. In some examples, the network entity 105 may update one or more parameters in an IE (e.g., the RRC IE) based on receiving the UE capability message to indicate multiple supplemental uplink frequency bands to the UE 115. Once the network entity 105 transmits the IE indicating the supplemental uplink frequency bands, which may include a table of supplemental uplink frequency bands, the network entity 105 may dynamically select one or more supplemental uplink frequency bands for the UE 115 to use for one or more uplink transmissions. In some examples, the UE 115 may transmit the uplink transmissions in accordance with the selected supplemental uplink frequency bands and a resource allocation in scheduling information.

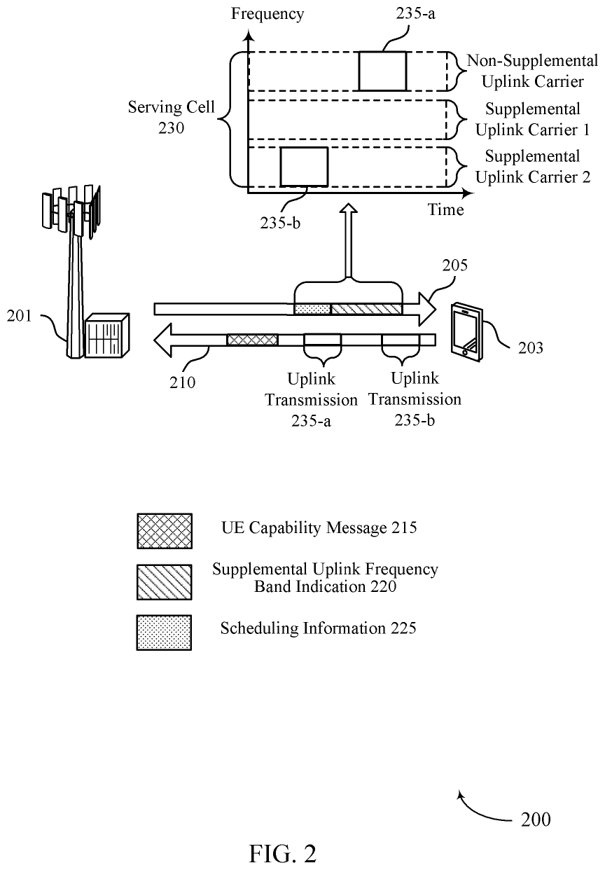

FIG. 2 illustrates an example of a wireless communications system that supports techniques for configuring multiple supplemental uplink frequency bands per serving cell in accordance with one or more aspects of the present disclosure. In some examples, a wireless communications system 200 may implement aspects of wireless communications system 100 and may include a UE 203 and a network entity 201, which may be examples of a UE 115 and a network entity 105 as described with reference to FIG. 1. In some examples, the network entity 201 may communicate control information, data, or both with the UE 203 using a downlink communication link 205. Similarly, the UE 203 may communicate control information, data or both with the network entity 201 using an uplink communication link, such as the uplink communication link 210.

In some examples, a serving cell 230 may be a logical communication entity used for communication with a wireless device (e.g., over a carrier). In some cases, a cell may refer to a portion of a geographic coverage area (e.g., a sector) over which the logical entity operates. A serving cell 230 may be a primary cell serving a primary carrier or a secondary cell serving a secondary carrier. For example, a serving cell 230 may serve one or more carriers, which may be referred to as component carriers. A carrier may span a set of radio frequency spectrum resources having a defined physical layer structure for supporting communications over a communication link. A carrier may be a frequency block or a set of frequency bands, and may be a primary carrier, secondary carrier, or supplemental uplink carrier. A primary carrier may be a carrier of a primary cell, which transmits uplink control and user data. A secondary carrier may refer to a carrier of a secondary cell, which may transmit data. In some cases, the wireless communications system 200 may implement a supplemental uplink carrier, or supplementary uplink carrier, which may be an additional carrier of a cell (e.g., primary cell, secondary cell, or both). In some examples, a serving cell 230 may support a primary carrier, or a non-supplemental uplink carrier, and one or more supplemental uplink carriers.

In some examples, a UE 203 may exchange system information to access a serving cell 230. For example, the UE 203 may periodically receive radio resource control (RRC) signaling, which may include one or more information elements (IEs). An IE may be a group of information which may be included within a signaling message, and may be sent across an interface, or transmitted between the UE 203 and the network entity 201. The IE may carry a system information block (SIB), a master information block (MIB), or both. The SIB may include a set of data that carries information relevant to the UE 203, while the MIB may include instructions and parameters transmitted by the network entity for the UE 203 that may provide for the UE 203 to decode the SIBs. Further, IEs, SIBS, and MIBs may be carried in control signaling, such as RRC signaling. In some examples, an IE in RRC signaling, an RRC IE, may include a MIB and a SIB configuring one or more carriers for the UE 203.

In some examples, a network entity 201, such as a base station, may dynamically relay control signaling to the UE 203. For example, the network entity 201 may use a downlink control information (DCI) message, which the network entity 201 may transmit to the UE 203 dynamically rather than periodically, such as when compared with RRC signaling. The network entity 201 may transmit the DCI message according to a defined format in which information may be packaged and transmitted, which may be referred to as a DCI format. A DCI format may be defined by fields and bits (e.g., DCI Format 0_0, DCI Format 0_1, DCI Format 2_0).

The network entity 201 may transmit a configuration for a supplemental uplink carrier for the UE 203 to use for an uplink transmission at a serving cell 230. For example, the network entity 201 may transmit control signaling (e.g., RRC signaling or a DCI message) indicating the supplemental uplink carrier. However, using a single supplemental uplink carrier per serving cell 230 may decrease uplink throughput when compared with using multiple supplemental uplink carriers per serving cell 230. Thus, the network entity 201 may configure multiple supplement uplink carriers per serving cell 230 by reusing one or more frequency bands as supplemental uplink frequency bands. For example, the network entity 201 may use one or more frequency bands spanning various frequency ranges (e.g., band n95 spanning 2010 through 2025 MHz, n97 spanning 2300 through 2400 MHz, n98 spanning 1880 through 1920 MHz) as supplemental uplink frequency bands.

In some cases, the UE 203 may determine a capability to support multiple supplemental uplink frequency bands per serving cell 230. For example, the UE 203 may be configured with or may otherwise define the capability to support the multiple supplemental uplink frequency bands per serving cell 230. The UE 203 may determine a maximum number of supplemental uplink frequency bands the UE 203 supports. The maximum may be based on one or more features of the UE 203 (e.g., a processing power of the UE 203, a battery life of the UE 203, a number of serving cells 230 in communication with the UE 203, and the like). In some cases, the capability of the UE 203 to support multiple supplemental uplink frequency bands per serving cell 230 may be based on the determined maximum. The UE 203 may transmit an indication of the maximum number of supported supplemental frequency bands to the network entity 201 in the UE capability message 215. In some examples, the multiple supplemental uplink frequency bands may span multiple supplemental uplink carriers. Thus, the capability of the UE 203 to support multiple supplemental uplink frequency bands per serving cell may also be a capability of the UE 203 to support multiple supplemental uplink carriers (e.g., component carriers) per serving cell 230. In some examples, the multiple supplemental uplink carriers and a non-supplemental uplink frequency carrier may correspond to a single downlink carrier (e.g., different than carrier aggregation). That is, the multiple supplemental uplink carriers may be bundled to a serving cell 230. The UE 203 may indicate to the network entity 201 whether the UE 203 supports multiple supplemental uplink carriers through a UE capability message 215.

The UE capability message 215 may include a new UE capability, which may be defined to support multiple supplemental uplink frequency bands per serving cell 230. In some examples, the UE 203 may transmit the UE capability message 215 to the network entity 201 in uplink control information via uplink communication link 210. The uplink control information may include one or more new parameters, such as a MultipleSULperServingCell parameter. The parameters may indicate whether the UE 203 supports more than one supplemental uplink per serving cell 230. For example, the parameter may be a binary indicator with a single bit, such that a bit value of 0 may indicate the UE 203 may not support multiple supplemental uplink carriers, and a bit value of 1 may indicate the UE 203 does support multiple supplemental uplink carriers. In some cases, the UE 203 may indicate whether the UE 203 supports more than one supplemental uplink carrier per serving cell 230 for a feature set, a band combination, or both. For example, the UE capability message 215 may include an indication of a set of frequency bands support by the UE 203 (e.g., bands A, B, C, and D, where B, C, and D may be supplemental uplink frequency bands).

In some cases, the UE 203 may transmit the UE capability message 215 independent of other UE capability signaling. Additionally, or alternatively, the UE 203 may indicate the UE capability message 215 in existing capability signaling. For example, the UE 203 may periodically transmit capability signaling indicating one or more capabilities of the UE 203 to support different types of signaling, such as during registration with the network entity 201. The UE 203 may include the indication that the UE 203 supports multiple supplemental uplink frequency bands, multiple carriers, or both, per serving cell 230 in the capability information. The network entity 201 may update an RRC IE, a DCI format, carrier scheduling, or any combination thereof in accordance with the UE capability message 215. For example, the network entity 201 may update one or more parameters in an IE (e.g., the RRC IE) based on receiving the UE capability message 215.

The network entity 201 may transmit a supplemental uplink frequency band indication 220 to the UE 203 on a downlink communication link 205. For example, the network entity 201 may periodically transmit RRC signaling, which may include the supplemental uplink frequency band indication 220. The RRC signaling may include one or more IEs (e.g., RRC IEs) that carry control information for the UE 203. An RRC IE may be updated to contain one or more additional entries, or parameters, for supplemental uplink bands. For example, a serving cell configuration IE (e.g., a ServingCellConfig IE, a ServingCellConfigCommonSIB IE, or both) may indicate a supplemental uplink frequency band, or carrier, group, such as by a supplementaryUplinkgroup parameter. The group may include multiple supplemental uplink frequency bands, or carriers, such as supplemental uplink carrier 1 and supplemental uplink carrier 2 (supplementaryUplink1, supplementaryUplink2, etc.). That is, one or more RRC IEs may configure the UE 203 with a list of supplemental uplink frequency bands, supplemental uplink carriers, or both, such as in a table (e.g., shown in Table 1).

TABLE 1
Uplink carrier configuration for a serving cell

| Uplink Carrier | |
|---|---|
| Index | Uplink Carrier |
| 00 | The Non-Supplemental Uplink Carrier |
| 01 | Supplemental Uplink Carrier 1 |
| 10 | Supplemental Uplink Carrier 2 |
| 11 | Supplemental Uplink Carrier 3 |

In some examples, as illustrated in Table 1, the supplemental uplink frequency band indication 220 may include a list of indices, or indicators, of an uplink carrier (e.g., non-supplemental uplink carrier or supplemental uplink carrier). Each index may be multiple bits, such as two or more bits. For example, for a two bit index, a 00 index value may indicate for the UE 203 to use a non-supplemental uplink carrier, a 01 index value may indicate for the UE 203 to use a supplemental uplink carrier 1, a 10 index value may indicate for the UE 203 to use a supplemental uplink carrier 2, and a 11 index value may indicate for the UE 203 to use a supplemental uplink carrier 3. In some cases, the index may be more than two bits, in which case the UE 203 may be configured with additional supplemental uplink carriers. In some cases, the index may indicate a set of frequency bands for the supplemental uplink carrier. In some other cases, the index may indicate the supplemental uplink carrier, and the UE 203 may infer the set of frequency bands for the supplemental uplink carrier.

Once the network entity 201 transmits the supplemental uplink frequency band indication 220, which may include a table (e.g., Table 1), the network entity 201 may dynamically select one or more supplemental uplink frequency bands for the UE 203 to use for an uplink transmission 235-a and an uplink transmission 235-b. For example, the network entity 201 may transmit a DCI message according to a DCI format (e.g., DCI Format 0_0), a MAC-CE, or the like. In some cases, the network entity 201 may include the dynamic selection of the supplemental uplink carriers in scheduling information 225. The scheduling information 225 may configure the UE 203 to transmit one or more uplink transmissions (e.g., uplink transmission 235-a and uplink transmission 235-b) on varying carriers for a single serving cell 230. Additionally, or alternatively, the scheduling information may one or more time-frequency resources for the uplink transmissions.

If the UE capability message 215 indicates that the UE 203 is not capable of supporting multiple supplemental uplink frequency bands, or carriers, per serving cell, the network entity 201 may refrain from transmitting the supplemental uplink frequency band indication 220. Similarly, the scheduling information 225 may include time-frequency resources, and the UE 203 may use the non-supplemental uplink carrier and a single set of supplemental uplink frequency bands, or a single supplemental uplink frequency carrier, rather than multiple.

In some cases, if the UE 203 is capable of supporting multiple supplemental uplink frequency bands, or carriers, the network entity 201 may update a DCI format of the scheduling information 225 for the uplink grant indicating the supplemental uplink carriers. For example, the network entity 201 may include one or more additional parameters to an existing DCI format (e.g., a supplementaryUplink parameter, a ServingCellConfig parameter, or both). The scheduling information 225 may include a value of an uplink or supplemental uplink indicator, as shown in Table 1. For example, the scheduling information 225 may indicate an index value of 00 for an uplink transmission 235-a for the UE 203 to use the non-supplemental uplink carrier and an index value of 10 for an uplink transmission 235-b for the UE 203 to use the supplemental uplink carrier 2. The non-supplemental uplink carrier and the supplemental uplink carrier 2 may be for a same serving cell 230.

In some examples, the UE 203 may transmit the uplink transmission 235-a and the uplink transmission 235-b in accordance with the scheduling information 225. For example, the UE 203 may transmit the uplink transmission 235-a to the network entity 201 on the scheduled non-supplemental uplink carrier. Similarly, the UE 203 may transmit the uplink transmission 235-b on the supplemental uplink carrier 2. The network entity 201 may not schedule an uplink transmission on the supplemental uplink carrier 1.

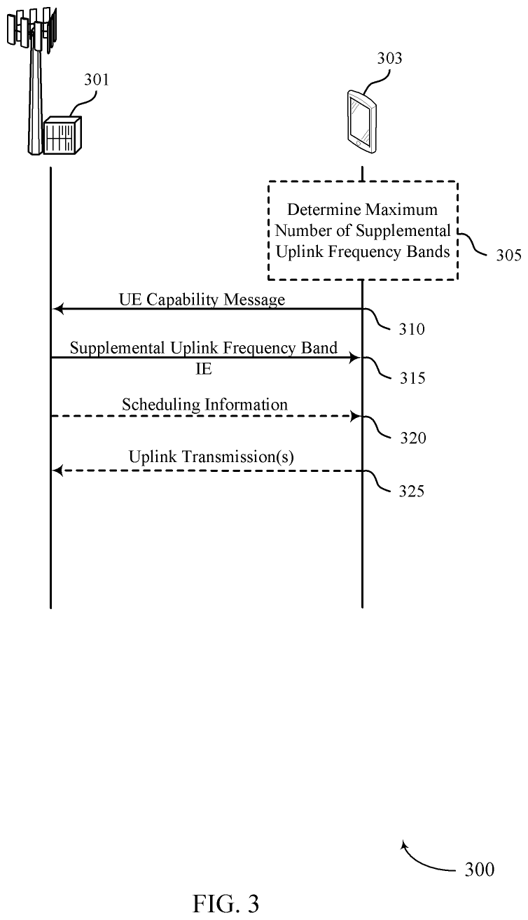

FIG. 3 illustrates an example of a process flow that supports techniques for configuring multiple supplemental uplink frequency bands per serving cell in accordance with one or more aspects of the present disclosure. In some examples, a process flow 300 may implement aspects of wireless communications system 100 and wireless communications system 200. The process flow 300 may illustrate an example of a UE 303 receiving multiple supplemental uplink frequency bands for a single serving cell based on a capability of the UE 303. Network entity 301 and UE 303 may be examples of a network entity 105 and UE 115 as described with reference to FIGS. 1 and 2. The network entity 301 may be a base station, one or more serving cells, or both. Alternative examples of the following may be implemented, where some processes are performed in a different order than described or are not performed. In some cases, processes may include additional features not mentioned below, or further processes may be added.

At 305, the UE 303 may determine a maximum number of supported supplemental uplink frequency bands. The maximum may be based on one or more features of the UE 303 (e.g., a processing power of the UE 303, a battery life of the UE 303, a number of serving cells in communication with the UE 303, and the like). In some cases, the supplemental uplink frequency bands may span multiple supplemental uplink carriers. Thus, the UE 303 may additionally, or alternatively, determine a maximum number of supported supplemental uplink carriers.

At 310, the UE 303 may transmit a message, or UE capability message, indicating a capability of the UE 303 to support multiple supplemental uplink frequency bands or supplemental uplink carriers bundled to a single serving cell. For example, the UE capability message may indicate the maximum number of supported supplemental uplink frequency bands or may indicate that the UE 303 is not capable of supporting multiple supplemental uplink frequency bands, or carriers, per serving cell. In some examples, the UE capability message may include a capability report with a parameter describing the capability of the UE 303 to support multiple supplemental uplink frequency bands. In some cases, the UE 303 may transmit the UE capability message in existing capability signaling, such as a periodic capability report. In some other cases, the UE 303 may transmit the UE capability message in separate capability signaling than the periodic capability report.

At 315, the UE 303 may receive an IE indicating supplemental uplink frequency bands in control signaling. In some examples, the control signaling may be periodic or semi-persistent signaling, such as RRC signaling or a MAC-CE. The IE may configure the UE 303 with multiple supplemental uplink frequency bands. In some examples, the multiple supplemental uplink frequency bands may span multiple supplemental uplink carriers. The supplemental uplink carriers may have a respective single downlink carrier, where the supplemental uplink carriers and downlink carrier may be bundled to (e.g., for) a single serving cell. In some cases, the IE may be an RRC IE, and may be updated to include parameters indicating the multiple supplemental uplink carriers. For example, the IE may include a list, or table (e.g., Table 1 as discussed with reference to FIG. 2), configuring the supplemental uplink frequency bands or supplemental uplink carriers at the UE 303. If the UE capability message at 310 indicates that the UE 303 does not support multiple supplemental uplink frequency bands, the network entity 301 may refrain from transmitting the supplemental uplink frequency band IE.

At 320, the UE 303 may receive scheduling information, or second control signaling, allocating resources for one or more uplink transmissions and indicating for the UE 303 to use at least one of the multiple supplemental uplink frequency bands for the uplink transmissions. The network entity 301 may include the scheduling information in a DCI message, a MAC-CE, or the like. In some examples, the scheduling information may include the scheduling of multiple uplink transmissions on a carrier frequency for the network entity 301, the multiple supplemental uplink carriers, or both. The scheduling information may include a multi-bit indicator, which may be any number of bits. The multi-bit indicator may indicate the at least one supplemental uplink frequency band for the uplink transmission. For example, the multi-bit indicator may select an index of a supplemental uplink carrier, or set of supplemental uplink frequency bands, from a configured list or table. In some other examples, the scheduling information may include another parameter indicating one or more supplemental uplink frequency bands, time-frequency resources, or both. Thus, the scheduling information may activate one or more supplemental frequency bands for the uplink transmissions. If the UE capability message at 310 indicates that the UE 303 does not support multiple supplemental uplink frequency bands per serving cell, the UE 303 may use the non-supplemental uplink carrier and a single set of supplemental uplink frequency bands, or a single supplemental uplink frequency carrier, rather than multiple.

At 325, the UE 303 may transmit one or more uplink transmissions, or one or more supplemental uplink frequency band transmissions, based on the supplemental uplink frequency band IE at 315 and the scheduling information at 320. In some examples, uplink transmission may be multiple transmissions, such as a first transmission on a supplemental uplink carrier 1 and a second uplink transmission on supplemental uplink carrier 2. The UE 303 may transmit the uplink transmissions to the network entity 301. In some examples, the UE 303 may transmit each uplink transmission on a set of supplemental uplink frequency bands in accordance with the multi-bit indicator transmitted by network entity 301. For example, the multi-bit indicator may specify to the UE 303 to transmit the first transmission on the supplemental uplink carrier 1. The same multi-bit indicator, or a different multi-bit indicator, may specify to the UE 303 to transmit the second transmission on the supplemental uplink carrier 2.

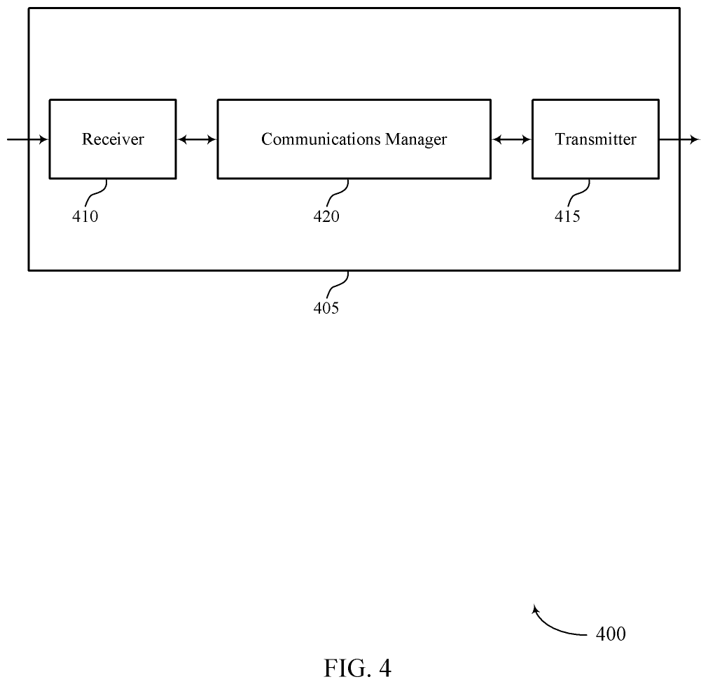

FIG. 4 shows a block diagram of a device that supports techniques for configuring multiple supplemental uplink frequency bands per serving cell in accordance with one or more aspects of the present disclosure. A device 405 of a block diagram 400 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for configuring multiple supplemental uplink frequency bands per serving cell). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for configuring multiple supplemental uplink frequency bands per serving cell). In some examples, the transmitter 415 may be co-located with a receiver 410 in a transceiver component. The transmitter 415 may utilize a single antenna or a set of multiple antennas.

The communications manager 420, the receiver 410, the transmitter 415, or various combinations thereof or various components thereof may be examples of means for performing various aspects of techniques for configuring multiple supplemental uplink frequency bands per serving cell as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication at a UE in accordance with examples as disclosed herein. For example, the communications manager 420 may be configured as or otherwise support a means for transmitting a message indicating a capability of the UE to support a set of multiple supplemental uplink frequency bands bundled to a serving cell. The communications manager 420 may be configured as or otherwise support a means for receiving first control signaling including an IE indicating the set of multiple supplemental uplink frequency bands, where the set of multiple supplemental uplink frequency bands correspond to a set of multiple supplemental uplink carriers corresponding to the serving cell.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for a UE to receive multiple supplemental uplink frequency bands bundled to a serving cell based on a capability of the UE, which may provide for reduced processing, reduced power consumption, more efficient utilization of communication resources, and the like.

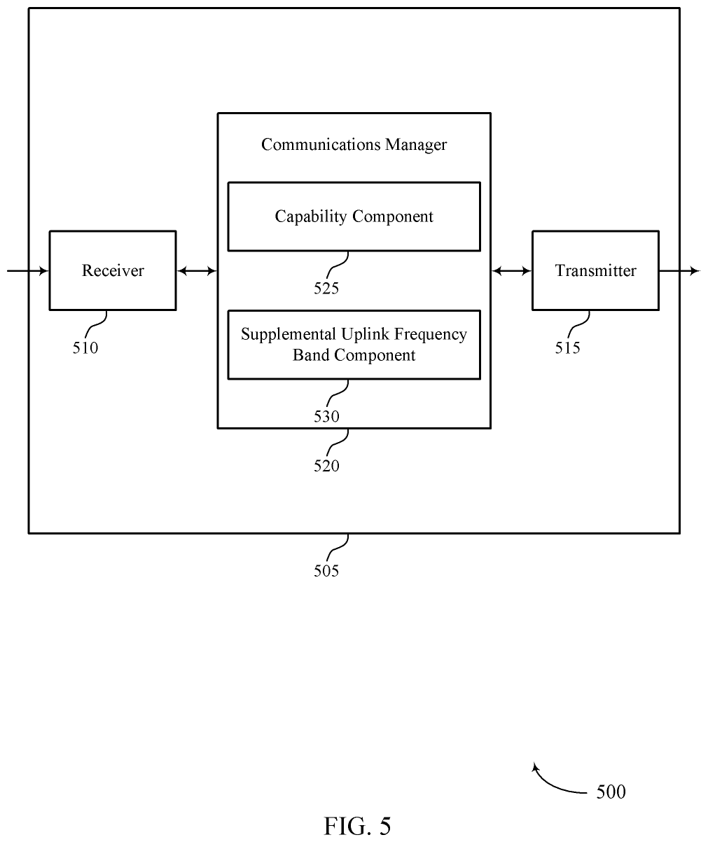

FIG. 5 shows a block diagram of a device that supports techniques for configuring multiple supplemental uplink frequency bands per serving cell in accordance with one or more aspects of the present disclosure. A device 505 of a block diagram 500 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for configuring multiple supplemental uplink frequency bands per serving cell). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for configuring multiple supplemental uplink frequency bands per serving cell). In some examples, the transmitter 515 may be co-located with a receiver 510 in a transceiver component. The transmitter 515 may utilize a single antenna or a set of multiple antennas.

The device 505, or various components thereof, may be an example of means for performing various aspects of techniques for configuring multiple supplemental uplink frequency bands per serving cell as described herein. For example, the communications manager 520 may include a capability component 525 a supplemental uplink frequency band component 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. The capability component 525 may be configured as or otherwise support a means for transmitting a message indicating a capability of the UE to support a set of multiple supplemental uplink frequency bands bundled to a serving cell. The supplemental uplink frequency band component 530 may be configured as or otherwise support a means for receiving first control signaling including an IE indicating the set of multiple supplemental uplink frequency bands, where the set of multiple supplemental uplink frequency bands correspond to a set of multiple supplemental uplink carriers corresponding to the serving cell.

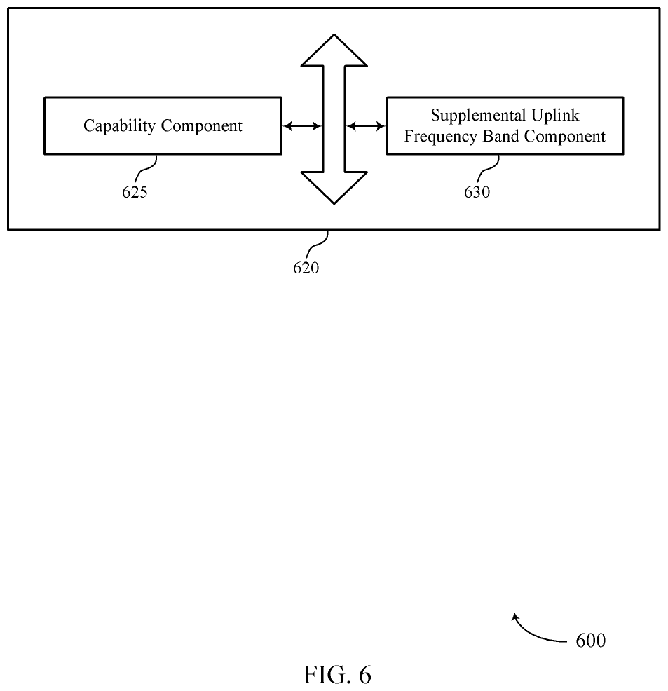

FIG. 6 shows a block diagram of a communications manager that supports techniques for configuring multiple supplemental uplink frequency bands per serving cell in accordance with one or more aspects of the present disclosure. A communications manager 620 of a block diagram 600 may be an example of aspects of a communications manager 420, a communications manager 520, or both, as described herein. The communications manager 620, or various components thereof, may be an example of means for performing various aspects of techniques for configuring multiple supplemental uplink frequency bands per serving cell as described herein. For example, the communications manager 620 may include a capability component 625 a supplemental uplink frequency band component 630, or any combination thereof. Each of these components may communicate, directly or indirectly, with one another (e.g., via one or more buses).

The communications manager 620 may support wireless communication at a UE in accordance with examples as disclosed herein. The capability component 625 may be configured as or otherwise support a means for transmitting a message indicating a capability of the UE to support a set of multiple supplemental uplink frequency bands bundled to a serving cell. The supplemental uplink frequency band component 630 may be configured as or otherwise support a means for receiving first control signaling including an IE indicating the set of multiple supplemental uplink frequency bands, where the set of multiple supplemental uplink frequency bands correspond to a set of multiple supplemental uplink carriers corresponding to the serving cell.

In some examples, the supplemental uplink frequency band component 630 may be configured as or otherwise support a means for receiving second control signaling including control information associated with at least one supplemental uplink frequency band of the set of multiple supplemental uplink frequency bands, the control information scheduling one or more uplink transmissions on a carrier frequency of the serving cell, the set of multiple supplemental uplink carriers, or both.

In some examples, the supplemental uplink frequency band component 630 may be configured as or otherwise support a means for receiving a multi-bit indicator in the control information, the multi-bit indicator corresponding to the at least one supplemental uplink frequency band of the set of multiple supplemental uplink frequency bands. In some examples, the supplemental uplink frequency band component 630 may be configured as or otherwise support a means for transmitting the one or more uplink transmissions on the at least one supplemental uplink frequency band based on the multi-bit indicator.

In some examples, the control information includes a parameter indicating the at least one supplemental uplink frequency band. In some examples, the control information activates the at least one supplemental uplink frequency band for the one or more uplink transmissions. In some examples, the control information includes DCI.

In some examples, the supplemental uplink frequency band component 630 may be configured as or otherwise support a means for determining a maximum number of supplemental uplink frequency bands, where a number of supplemental uplink frequency bands supported by the UE is based on the maximum number of supplemental uplink frequency bands.

In some examples, the message includes a capability report, the capability of the UE to support the set of multiple supplemental uplink frequency bands being a parameter of the capability report.

In some examples, the first control signaling includes RRC signaling. In some examples, the set of supplemental uplink carriers are for a single downlink carrier of the serving cell.

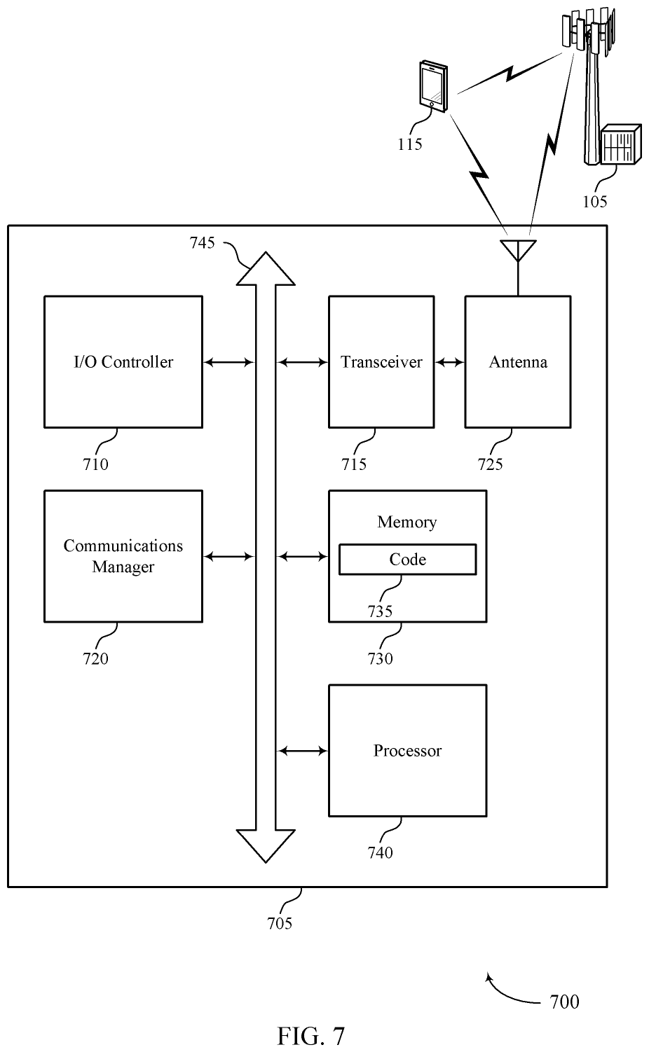

FIG. 7 shows a diagram of a system including a device that supports techniques for configuring multiple supplemental uplink frequency bands per serving cell in accordance with one or more aspects of the present disclosure. A device 705 of a system 700 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting techniques for configuring multiple supplemental uplink frequency bands per serving cell). For example, the device 705 or a component of the device 705 may include a processor 740 and memory 730 coupled with or to the processor 740, the processor 740 and memory 730 configured to perform various functions described herein.

The communications manager 720 may support wireless communication at a UE in accordance with examples as disclosed herein. For example, the communications manager 720 may be configured as or otherwise support a means for transmitting a message indicating a capability of the UE to support a set of multiple supplemental uplink frequency bands bundled to a serving cell. The communications manager 720 may be configured as or otherwise support a means for receiving first control signaling including an IE indicating the set of multiple supplemental uplink frequency bands, where the set of multiple supplemental uplink frequency bands correspond to a set of multiple supplemental uplink carriers corresponding to the serving cell.

By including or configuring the communications manager 720 in accordance with examples as described herein, the device 705 may support techniques for a UE to receive multiple supplemental uplink frequency bands bundled to a serving cell based on a capability of the UE, which may provide for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of techniques for configuring multiple supplemental uplink frequency bands per serving cell as described herein, or the processor 740 and the memory 730 may be otherwise configured to perform or support such operations.

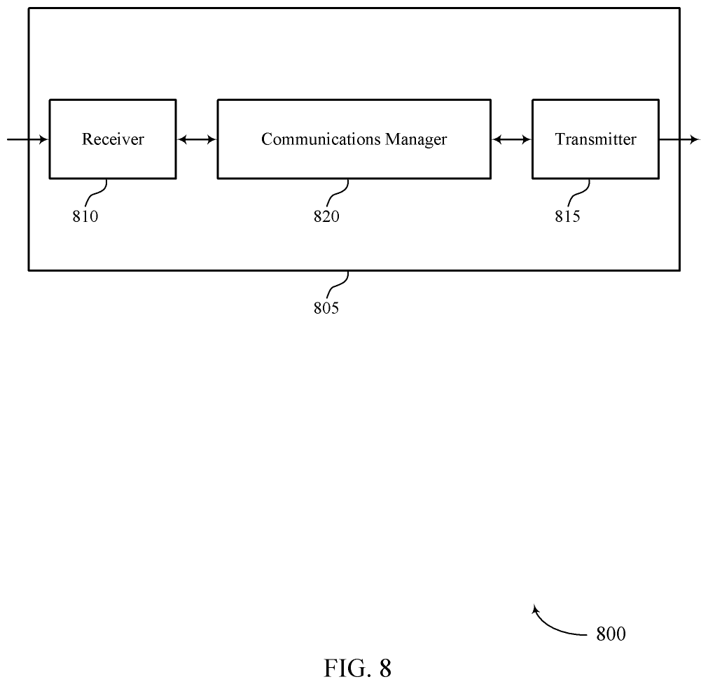

FIG. 8 shows a block diagram of a device that supports techniques for configuring multiple supplemental uplink frequency bands per serving cell in accordance with one or more aspects of the present disclosure. A device 805 of a block diagram 800 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of techniques for configuring multiple supplemental uplink frequency bands per serving cell as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a network entity in accordance with examples as disclosed herein. For example, the communications manager 820 may be configured as or otherwise support a means for receiving a message indicating a capability of a UE to support a set of multiple supplemental uplink frequency bands bundled to a serving cell. The communications manager 820 may be configured as or otherwise support a means for transmitting first control signaling including an IE indicating the set of multiple supplemental uplink frequency bands, where the set of multiple supplemental uplink frequency bands are associated with a set of multiple supplemental uplink carriers for the serving cell.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for a UE to receive multiple supplemental uplink frequency bands bundled to a serving cell based on a capability of the UE, which may provide for reduced processing, reduced power consumption, more efficient utilization of communication resources, and the like.

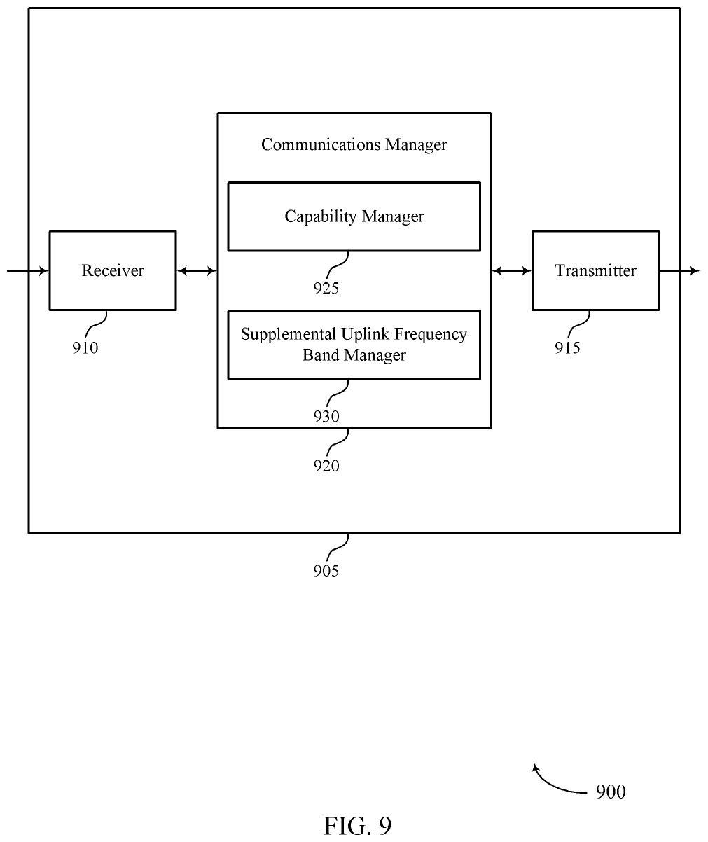

FIG. 9 shows a block diagram of a device that supports techniques for configuring multiple supplemental uplink frequency bands per serving cell in accordance with one or more aspects of the present disclosure. A device 905 of a block diagram 900 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of techniques for configuring multiple supplemental uplink frequency bands per serving cell as described herein. For example, the communications manager 920 may include a capability manager 925 a supplemental uplink frequency band manager 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. The capability manager 925 may be configured as or otherwise support a means for receiving a message indicating a capability of a UE to support a set of multiple supplemental uplink frequency bands bundled to a serving cell. The supplemental uplink frequency band manager 930 may be configured as or otherwise support a means for transmitting first control signaling including an IE indicating the set of multiple supplemental uplink frequency bands, where the set of multiple supplemental uplink frequency bands are associated with a set of multiple supplemental uplink carriers for the serving cell.

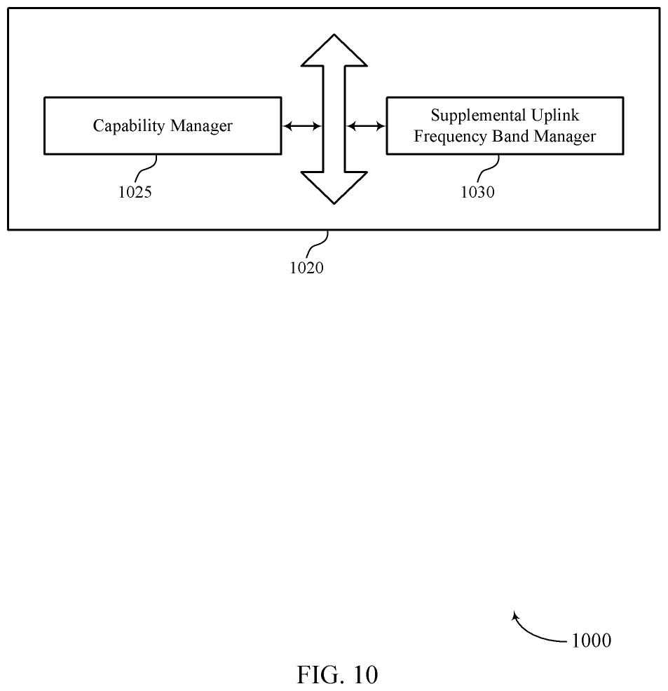

FIG. 10 shows a block diagram of a communications manager that supports techniques for configuring multiple supplemental uplink frequency bands per serving cell in accordance with one or more aspects of the present disclosure. A communications manager 1020 of a block diagram 1000 may be an example of aspects of a communications manager 820, a communications manager 920, or both, as described herein. The communications manager 1020, or various components thereof, may be an example of means for performing various aspects of techniques for configuring multiple supplemental uplink frequency bands per serving cell as described herein. For example, the communications manager 1020 may include a capability manager 1025 a supplemental uplink frequency band manager 1030, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communication at a network entity in accordance with examples as disclosed herein. The capability manager 1025 may be configured as or otherwise support a means for receiving a message indicating a capability of a UE to support a set of multiple supplemental uplink frequency bands bundled to a serving cell. The supplemental uplink frequency band manager 1030 may be configured as or otherwise support a means for transmitting first control signaling including an IE indicating the set of multiple supplemental uplink frequency bands, where the set of multiple supplemental uplink frequency bands are associated with a set of multiple supplemental uplink carriers for the serving cell.

In some examples, the supplemental uplink frequency band manager 1030 may be configured as or otherwise support a means for transmitting second control signaling including control information associated with at least one supplemental uplink frequency band of the set of multiple supplemental uplink frequency bands, the control information scheduling one or more uplink transmissions on a carrier frequency of the serving cell, the set of multiple supplemental uplink carriers, or both.

In some examples, the supplemental uplink frequency band manager 1030 may be configured as or otherwise support a means for transmitting a multi-bit indicator in the control information, the multi-bit indicator corresponding to the at least one supplemental uplink frequency band of the set of multiple supplemental uplink frequency bands. In some examples, the supplemental uplink frequency band manager 1030 may be configured as or otherwise support a means for receiving the one or more uplink transmissions on the at least one supplemental uplink frequency band based on the multi-bit indicator.

In some examples, the control information includes a parameter indicating the at least one supplemental uplink frequency band. In some examples, the control information activates the at least one supplemental uplink frequency band for the one or more uplink transmissions. In some examples, the control information includes DCI.

In some examples, the message includes a capability report, the capability of the UE to support the set of multiple supplemental uplink frequency bands being a parameter of the capability report.

In some examples, the first control signaling may be RRC signaling. In some examples, the set of supplemental uplink carriers are for a single downlink carrier of the serving cell.

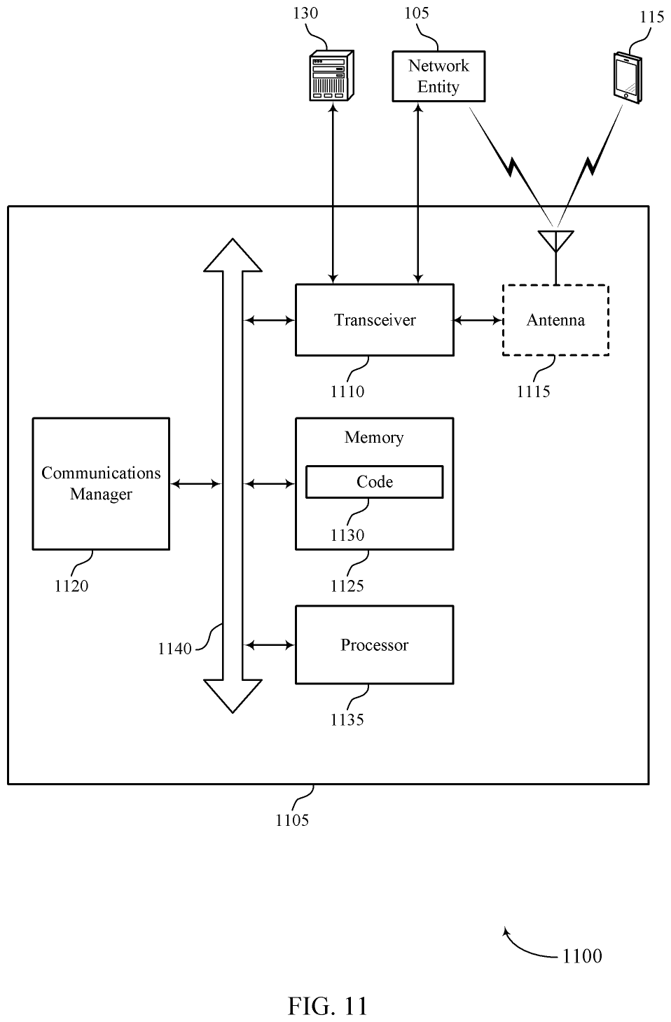

FIG. 11 shows a diagram of a system including a device that supports techniques for configuring multiple supplemental uplink frequency bands per serving cell in accordance with one or more aspects of the present disclosure. A device 1105 of a system 1100 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. The transceiver 1110, or the transceiver 1110 and one or more antennas 1115 or wired interfaces, where applicable, may be an example of a transmitter 815, a transmitter 915, a receiver 810, a receiver 910, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting techniques for configuring multiple supplemental uplink frequency bands per serving cell). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communication at a network entity in accordance with examples as disclosed herein. For example, the communications manager 1120 may be configured as or otherwise support a means for receiving a message indicating a capability of a UE to support a set of multiple supplemental uplink frequency bands bundled to a serving cell. The communications manager 1120 may be configured as or otherwise support a means for transmitting first control signaling including an IE indicating the set of multiple supplemental uplink frequency bands, where the set of multiple supplemental uplink frequency bands are associated with a set of multiple supplemental uplink carriers corresponding to the serving cell.

By including or configuring the communications manager 1120 in accordance with examples as described herein, the device 1105 may support techniques for a UE to receive multiple supplemental uplink frequency bands bundled to a serving cell based on a capability of the UE, which may provide for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the processor 1135, the memory 1125, the code 1130, the transceiver 1110, or any combination thereof. For example, the code 1130 may include instructions executable by the processor 1135 to cause the device 1105 to perform various aspects of techniques for configuring multiple supplemental uplink frequency bands per serving cell as described herein, or the processor 1135 and the memory 1125 may be otherwise configured to perform or support such operations.

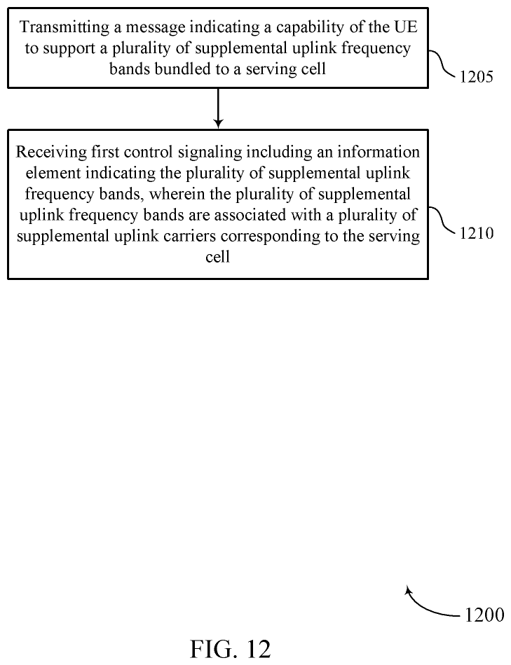

FIG. 12 shows a flowchart illustrating a method that supports techniques for configuring multiple supplemental uplink frequency bands per serving cell in accordance with one or more aspects of the present disclosure. The operations of a method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include transmitting a message indicating a capability of the UE to support a set of multiple supplemental uplink frequency bands bundled to a serving cell. The operations of 1205 may be performed in accordance with examples as disclosed herein. In some examples, aspects of the operations of 1205 may be performed by a capability component 625 as described with reference to FIG. 6.

At 1210, the method may include receiving first control signaling including an IE indicating the set of multiple supplemental uplink frequency bands, where the set of multiple supplemental uplink frequency bands are associated with a set of multiple supplemental uplink carriers corresponding to the serving cell. The operations of 1210 may be performed in accordance with examples as disclosed herein. In some examples, aspects of the operations of 1210 may be performed by a supplemental uplink frequency band component 630 as described with reference to FIG. 6.

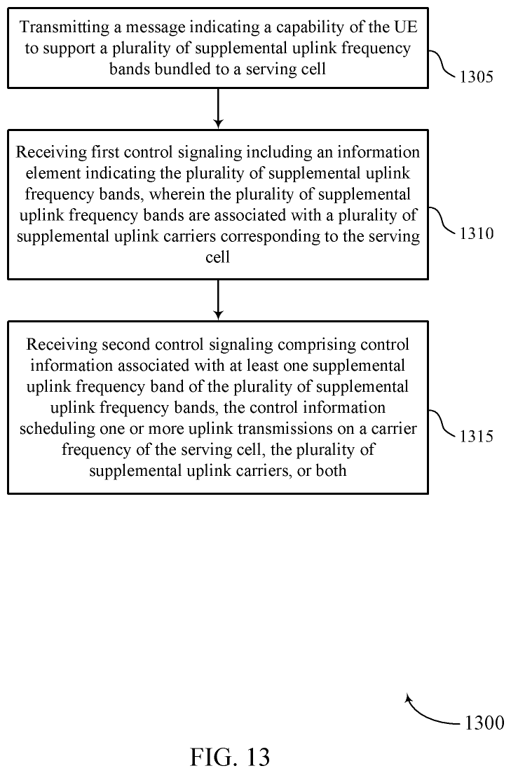

FIG. 13 shows a flowchart illustrating a method that supports techniques for configuring multiple supplemental uplink frequency bands per serving cell in accordance with one or more aspects of the present disclosure. The operations of a method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include transmitting a message indicating a capability of the UE to support a set of multiple supplemental uplink frequency bands bundled to a serving cell. The operations of 1305 may be performed in accordance with examples as disclosed herein. In some examples, aspects of the operations of 1305 may be performed by a capability component 625 as described with reference to FIG. 6.

At 1310, the method may include receiving first control signaling including an IE indicating the set of multiple supplemental uplink frequency bands, where the set of multiple supplemental uplink frequency bands are associated with a set of multiple supplemental uplink carriers corresponding to the serving cell. The operations of 1310 may be performed in accordance with examples as disclosed herein. In some examples, aspects of the operations of 1310 may be performed by a supplemental uplink frequency band component 630 as described with reference to FIG. 6.

At 1315, the method may include receiving second control signaling including control information associated with at least one supplemental uplink frequency band of the set of multiple supplemental uplink frequency bands, the control information scheduling one or more uplink transmissions on a carrier frequency of the serving cell, the set of multiple supplemental uplink carriers, or both. The operations of 1315 may be performed in accordance with examples as disclosed herein. In some examples, aspects of the operations of 1315 may be performed by a supplemental uplink frequency band component 630 as described with reference to FIG. 6.

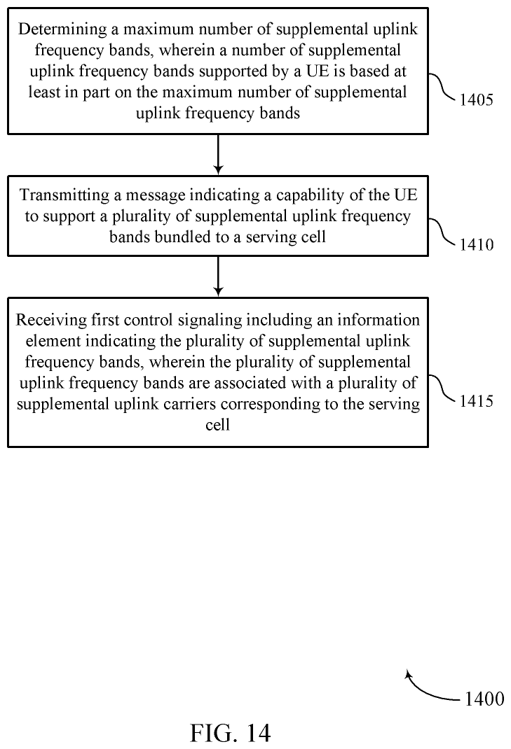

FIG. 14 shows a flowchart illustrating a method that supports techniques for configuring multiple supplemental uplink frequency bands per serving cell in accordance with one or more aspects of the present disclosure. The operations of a method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1405, the method may include determining a maximum number of supplemental uplink frequency bands, where a number of supplemental uplink frequency bands supported by a UE is based on the maximum number of supplemental uplink frequency bands. The operations of 1405 may be performed in accordance with examples as disclosed herein. In some examples, aspects of the operations of 1405 may be performed by a supplemental uplink frequency band component 630 as described with reference to FIG. 6.

At 1410, the method may include transmitting a message indicating a capability of the UE to support a set of multiple supplemental uplink frequency bands bundled to a serving cell. The operations of 1410 may be performed in accordance with examples as disclosed herein. In some examples, aspects of the operations of 1410 may be performed by a capability component 625 as described with reference to FIG. 6.

At 1415, the method may include receiving first control signaling including an IE indicating the set of multiple supplemental uplink frequency bands, where the set of multiple supplemental uplink frequency bands are associated with a set of multiple supplemental uplink carriers corresponding to the serving cell. The operations of 1415 may be performed in accordance with examples as disclosed herein. In some examples, aspects of the operations of 1415 may be performed by a supplemental uplink frequency band component 630 as described with reference to FIG. 6.

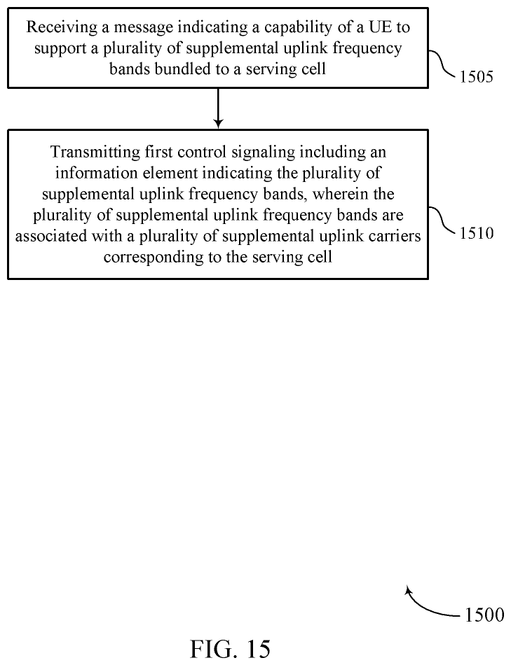

FIG. 15 shows a flowchart illustrating a method that supports techniques for configuring multiple supplemental uplink frequency bands per serving cell in accordance with one or more aspects of the present disclosure. The operations of a method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include receiving a message indicating a capability of a UE to support a set of multiple supplemental uplink frequency bands bundled to a serving cell. The operations of 1505 may be performed in accordance with examples as disclosed herein. In some examples, aspects of the operations of 1505 may be performed by a capability manager 1025 as described with reference to FIG. 10.

At 1510, the method may include transmitting first control signaling including an IE indicating the set of multiple supplemental uplink frequency bands, where the set of multiple supplemental uplink frequency bands are associated with a set of multiple supplemental uplink carriers corresponding to the serving cell. The operations of 1510 may be performed in accordance with examples as disclosed herein. In some examples, aspects of the operations of 1510 may be performed by a supplemental uplink frequency band manager 1030 as described with reference to FIG. 10.

The following provides an overview of aspects of the present disclosure:

Aspect 1: A method for wireless communication at a UE, comprising: transmitting a message indicating a capability of the UE to support a plurality of supplemental uplink frequency bands bundled to a serving cell; and receiving first control signaling including an information element indicating the plurality of supplemental uplink frequency bands, wherein the plurality of supplemental uplink frequency bands are associated with a plurality of supplemental uplink carriers corresponding to the serving cell.

Aspect 2: The method of aspect 1, further comprising: receiving second control signaling comprising control information associated with at least one supplemental uplink frequency band of the plurality of supplemental uplink frequency bands, the control information scheduling one or more uplink transmissions on a carrier frequency of the serving cell, the plurality of supplemental uplink carriers, or both.

Aspect 3: The method of aspect 2, further comprising: receiving a multi-bit indicator in the control information, the multi-bit indicator corresponding to the at least one supplemental uplink frequency band of the plurality of supplemental uplink frequency bands; and transmitting the one or more uplink transmissions on the at least one supplemental uplink frequency band based at least in part on the multi-bit indicator.

Aspect 4: The method of any of aspects 2 through 3, wherein the control information comprises a parameter indicating the at least one supplemental uplink frequency band.

Aspect 5: The method of any of aspects 2 through 4, wherein the control information activates the at least one supplemental uplink frequency band for the one or more uplink transmissions.

Aspect 6: The method of any of aspects 2 through 5, wherein the control information comprises downlink control information.

Aspect 7: The method of any of aspects 1 through 6, further comprising:

determining a maximum number of supplemental uplink frequency bands, wherein a number of supplemental uplink frequency bands supported by the UE is based at least in part on the maximum number of supplemental uplink frequency bands.

Aspect 8: The method of any of aspects 1 through 7, wherein the message comprises a capability report, the capability of the UE to support the plurality of supplemental uplink frequency bands being a parameter of the capability report.

Aspect 9: The method of any of aspects 1 through 8, wherein the first control signaling comprises radio resource control signaling.

Aspect 10: The method of any of aspects 1 through 9, wherein the plurality of supplemental uplink carriers correspond to a single downlink carrier of the serving cell.

Aspect 11: A method for wireless communication at a network entity, comprising: receiving a message indicating a capability of a UE to support a plurality of supplemental uplink frequency bands bundled to a serving cell; and transmitting first control signaling including an information element indicating the plurality of supplemental uplink frequency bands, wherein the plurality of supplemental uplink frequency bands are associated with a plurality of supplemental uplink carriers corresponding to the serving cell.

Aspect 12: The method of aspect 11, further comprising: transmitting second control signaling comprising control information associated with at least one supplemental uplink frequency band of the plurality of supplemental uplink frequency bands, the control information scheduling one or more uplink transmissions on a carrier frequency of the serving cell, the plurality of supplemental uplink carriers, or both.

Aspect 13: The method of aspect 12, further comprising: transmitting a multi-bit indicator in the control information, the multi-bit indicator corresponding to the at least one supplemental uplink frequency band of the plurality of supplemental uplink frequency bands; and receiving the one or more uplink transmissions on the at least one supplemental uplink frequency band based at least in part on the multi-bit indicator.

Aspect 14: The method of any of aspects 12 through 13, wherein the control information comprises a parameter indicating the at least one supplemental uplink frequency band.

Aspect 15: The method of any of aspects 12 through 14, wherein the control information activates the at least one supplemental uplink frequency band for the one or more uplink transmissions.

Aspect 16: The method of any of aspects 12 through 15, wherein the control information comprises downlink control information.

Aspect 17: The method of any of aspects 11 through 16, wherein the message comprises a capability report, the capability of the UE to support the plurality of supplemental uplink frequency bands being a parameter of the capability report.

Aspect 18: The method of any of aspects 11 through 17, wherein the first control signaling comprises radio resource control signaling.

Aspect 19: The method of any of aspects 11 through 18, wherein the plurality of supplemental uplink carriers correspond to a single downlink carrier of the serving cell.

Aspect 20: An apparatus for wireless communication at a UE, comprising a processor; memory coupled with the processor; and instructions stored in the memory and executable by the processor to cause the apparatus to perform a method of any of aspects 1 through 10.

Aspect 21: An apparatus for wireless communication at a UE, comprising at least one means for performing a method of any of aspects 1 through 10.

Aspect 22: A non-transitory computer-readable medium storing code for wireless communication at a UE, the code comprising instructions executable by a processor to perform a method of any of aspects 1 through 10.

Aspect 23: An apparatus for wireless communication at a network entity, comprising a processor; memory coupled with the processor; and instructions stored in the memory and executable by the processor to cause the apparatus to perform a method of any of aspects 11 through 19.

Aspect 24: An apparatus for wireless communication at a network entity, comprising at least one means for performing a method of any of aspects 11 through 19.

Aspect 25: A non-transitory computer-readable medium storing code for wireless communication at a network entity, the code comprising instructions executable by a processor to perform a method of any of aspects 11 through 19.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
transmitting a message indicating a capability of the UE to support a plurality of supplemental uplink frequency bands bundled to a serving cell; and
receiving first control signaling including an information element indicating the plurality of supplemental uplink frequency bands, wherein the plurality of supplemental uplink frequency bands are associated with a plurality of supplemental uplink carriers corresponding to the serving cell.

2. The method of claim 1, further comprising:
receiving second control signaling comprising control information associated with at least one supplemental uplink frequency band of the plurality of supplemental uplink frequency bands, the control information scheduling one or more uplink transmissions on a carrier frequency of the serving cell, the plurality of supplemental uplink carriers, or both.

3. The method of claim 2, further comprising:
receiving a multi-bit indicator in the control information, the multi-bit indicator corresponding to the at least one supplemental uplink frequency band of the plurality of supplemental uplink frequency bands; and
transmitting the one or more uplink transmissions on the at least one supplemental uplink frequency band based at least in part on the multi-bit indicator.

4. The method of claim 2, wherein the control information comprises a parameter indicating the at least one supplemental uplink frequency band.

5. The method of claim 2, wherein the control information activates the at least one supplemental uplink frequency band for the one or more uplink transmissions.

6. The method of claim 2, wherein the control information comprises downlink control information.

7. The method of claim 1, further comprising:
determining a maximum number of supplemental uplink frequency bands, wherein a number of supplemental uplink frequency bands supported by the UE is based at least in part on the maximum number of supplemental uplink frequency bands.

8. The method of claim 1, wherein the message comprises a capability report, the capability of the UE to support the plurality of supplemental uplink frequency bands being a parameter of the capability report.

9. The method of claim 1, wherein the first control signaling comprises radio resource control signaling.

10. The method of claim 1, wherein the plurality of supplemental uplink carriers correspond to a single downlink carrier of the serving cell.

11. A method for wireless communication at a network entity, comprising:
receiving a message indicating a capability of a user equipment (UE) to support a plurality of supplemental uplink frequency bands bundled to a serving cell; and
transmitting first control signaling including an information element indicating the plurality of supplemental uplink frequency bands, wherein the plurality of supplemental uplink frequency bands are associated with a plurality of supplemental uplink carriers corresponding to the serving cell.

12. The method of claim 11, further comprising:
transmitting second control signaling comprising control information associated with at least one supplemental uplink frequency band of the plurality of supplemental uplink frequency bands, the control information scheduling one or more uplink transmissions on a carrier frequency of the serving cell, the plurality of supplemental uplink carriers, or both.

13. The method of claim 12, further comprising:
transmitting a multi-bit indicator in the control information, the multi-bit indicator corresponding to the at least one supplemental uplink frequency band of the plurality of supplemental uplink frequency bands; and
receiving the one or more uplink transmissions on the at least one supplemental uplink frequency band based at least in part on the multi-bit indicator.

14. The method of claim 12, wherein the control information comprises a parameter indicating the at least one supplemental uplink frequency band.

15. The method of claim 12, wherein the control information activates the at least one supplemental uplink frequency band for the one or more uplink transmissions.

16. The method of claim 12, wherein the control information comprises downlink control information.

17. The method of claim 11, wherein the message comprises a capability report, the capability of the UE to support the plurality of supplemental uplink frequency bands being a parameter of the capability report.

18. The method of claim 11, wherein the first control signaling comprises radio resource control signaling.

19. The method of claim 11, wherein the plurality of supplemental uplink carriers correspond to a single downlink carrier of the serving cell.

20. An apparatus for wireless communication at a user equipment (UE), comprising:
a processor;
memory coupled with the processor; and
instructions stored in the memory and executable by the processor to cause the apparatus to:
transmit a message indicating a capability of the UE to support a plurality of supplemental uplink frequency bands bundled to a serving cell; and
receive first control signaling including an information element indicating the plurality of supplemental uplink frequency bands, wherein the plurality of supplemental uplink frequency bands are associated with a plurality of supplemental uplink carriers corresponding to the serving cell.

21. The apparatus of claim 20, wherein the instructions are further executable by the processor to cause the apparatus to:
receive second control signaling comprising control information associated with at least one supplemental uplink frequency band of the plurality of supplemental uplink frequency bands, the control information scheduling one or more uplink transmissions on a carrier frequency of the serving cell, the plurality of supplemental uplink carriers, or both.

22. The apparatus of claim 21, wherein the instructions are further executable by the processor to cause the apparatus to:
receive a multi-bit indicator in the control information, the multi-bit indicator corresponding to the at least one supplemental uplink frequency band of the plurality of supplemental uplink frequency bands; and
transmit the one or more uplink transmissions on the at least one supplemental uplink frequency band based at least in part on the multi-bit indicator.

23. The apparatus of claim 21, wherein the control information comprises a parameter indicating the at least one supplemental uplink frequency band.

24. The apparatus of claim 21, wherein the control information activates the at least one supplemental uplink frequency band for the one or more uplink transmissions.

25. The apparatus of claim 21, wherein the control information comprises downlink control information.

26. The apparatus of claim 20, wherein the instructions are further executable by the processor to cause the apparatus to:
determine a maximum number of supplemental uplink frequency bands, wherein a number of supplemental uplink frequency bands supported by the UE is based at least in part on the maximum number of supplemental uplink frequency bands.

27. The apparatus of claim 20, wherein the message comprises a capability report, the capability of the UE to support the plurality of supplemental uplink frequency bands being a parameter of the capability report.

28. The apparatus of claim 20, wherein the first control signaling comprises radio resource control signaling.

29. The apparatus of claim 20, wherein the plurality of supplemental uplink carriers correspond to a single downlink carrier of the serving cell.

30. An apparatus for wireless communication at a network entity, comprising:
a processor;
memory coupled with the processor; and
instructions stored in the memory and executable by the processor to cause the apparatus to:
receive a message indicating a capability of a user equipment (UE) to support a plurality of supplemental uplink frequency bands bundled to a serving cell; and
transmit first control signaling including an information element indicating the plurality of supplemental uplink frequency bands, wherein the plurality of supplemental uplink frequency bands are associated with a plurality of supplemental uplink carriers corresponding to the serving cell.
